(19) United States
(12) Patent Application Publication
(10) Pub. No.: US 2006/0053467 A1
(43) Pub. Date: Mar. 9, 2006

(54) Broadcast receiver

(75) Inventor: Shingo Ikeda, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/216,107

(22) Filed: Sep. 1, 2005

(30) Foreign Application Priority Data
Sep. 3, 2004 (JP) 2004-257548

(51) Int. Cl. H04N 7/173; H04N 7/16

(52) U.S. Cl. 725/134; 725/142; 725/89

(57) ABSTRACT

A digital television broadcast receiver improves a convenience of a user by making a video recording reservation by using a function control mail and making the video recording reservation from a distance. The broadcast receiver has a mail receiving section, a mail type identification section to identify a normal mail and the function control mail when the mail receiving section receives a mail and a video recording reservation section to generate video recording reservation information by analyzing at least a keyword, a video recording channel and a video recording time and make a video recording reservation when the received mail is the function control mail.

### CROSS-REFERENCE TO RELATED APPLICATIONS

This application is based upon and claims the benefit of priority from prior Japanese Patent Application No. 2004-257548, filed Sep. 3, 2004, the entire contents of which are incorporated herein by reference.

### BACKGROUND OF THE INVENTION

1. Field of the Invention

The present invention relates to a broadcast receiver for receiving, for example, digital television broadcast.

2. Description of the Related Art

As is well known, in recent years, digitization of television broadcasting has accelerated. In Japan, for example, not only satellite digital broadcasting such as digital broadcasting and 110° communication satellite (CS) digital broadcasting but also terrestrial digital television broadcasting has been started.

It has become possible for a digital broadcast receiver for receiving such digital television broadcasts to digitally record the received program or reproduce the recorded program by connecting digital recording equipment such as a hard disk drive (HDD).

Nowadays, it is possible for the digital broadcast receiver to specify any digital recording equipment for recording a program and reproducing the recorded program by connecting a plurality of sets of digital recording equipment to configure a network for a single digital broadcast receiver.

A configuration to enable recognizing a connection state based on a telephone line even in such a state that a television receiver with an Internet receiving section outputs sound of a television signal from a loudspeaker is disclosed in Jpn. Pat. Appln. KOKAI Publication No. 10-136275.

### BRIEF SUMMARY OF THE INVENTION

It is desired for the above-mentioned digital broadcast receiver to be added a section to receive mail via the Internet or a telephone line. In the event of addition of a mail reception processing section, the broadcast receiver is desired to effectively utilize the processing section.

An object of the embodiments of the invention is to provide a broadcast receiver to effectively utilize a mail reception processing section and to process a normal mail and a function control mail. Here the normal mail means the mail to be communicated by characters like a document and the function control mail means the mail including control data to control a plurality of sets of peripheral equipment attached to the above-described broadcast receiver or make video recording reservations for the sets of the equipment.

An object of another embodiment of the invention is to provide a broadcast receiver enabling a user to make the recording reservations from a distance through the function control mail and to meet the convenience of the user.

A broadcast receiver regarding an embodiment of the invention has a mail receiving section, a mail type identification section to identify a normal mail and a function control mail when the mail receiving section receives the mail, and a video recording reservation section to generate video recording reservation information and make a video recording reservation by analyzing at least a keyword, a recording channel and a recording time in the function control mail and make the video recording reservation when the received mail is the function control mail.

According to the above-stated broadcast receiver, if the received mail is the function control mail, the broadcast receiver can automatically analyze mail information and make the video recording reservation for a program and a user can make the video recording reservation even from an outside location.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows an embodiment of the invention and is a view for schematically explaining a digital television broadcast receiver and an example of a network configured around the broadcast receiver as a center;

FIG. 2 is a block diagram for explaining a principal signal processing system of the broadcast receiver in the embodiment in FIG. 1;

FIG. 3 is an external view for explaining a remote controller of the broadcast receiver in the embodiment in FIG. 1;

FIG. 4 is a flowchart for explaining operations in which the broadcast receiver in the embodiment in FIG. 1 controls digital recording equipment to record a program thereby;

FIG. 5 is a view for explaining an example of a program table displayed on a display unit when the program is recorded by the recording equipment in the embodiment in FIG. 1;

FIG. 6 is a flowchart for explaining operations of reproduction of the program from the recording equipment by the broadcast receiver in the embodiment in FIG. 1;

FIG. 7 is a view for explaining an example of a navigation menu displayed on the display unit when reproduction operations are performed in the broadcast receiver in the embodiment in FIG. 1;

FIG. 8 is a view for explaining a state in which items of video recorded programs are selected from the navigation menu;

FIG. 9 is a view for explaining an example of a list display screen, wherein the list is for recently recorded programs and can be obtained from the navigation menu;

FIG. 10 is a view for explaining a photograph reproduction section of the broadcast receiver in the embodiment in FIG. 1;

FIG. 11 is a view for explaining an example of an E-mail incoming screen of the broadcast receiver in the embodiment in FIG. 1;

FIG. 12 is a view for explaining an example of an E-mail display screen of the broadcast receiver in the embodiment in FIG. 1;

FIG. 13 is a view for explaining a transmitting/receiving path of E-mail of the broadcast receiver in the embodiment in FIG. 1;

FIG. 14A-FIG. 14D are views for explaining an example of a format of the function control mail in the embodiment in FIG. 1; and

FIG. 15 is a flowchart for explaining mail information processing of the broadcast receiver in the embodiment in FIG. 1.

### DETAILED DESCRIPTION OF THE INVENTION

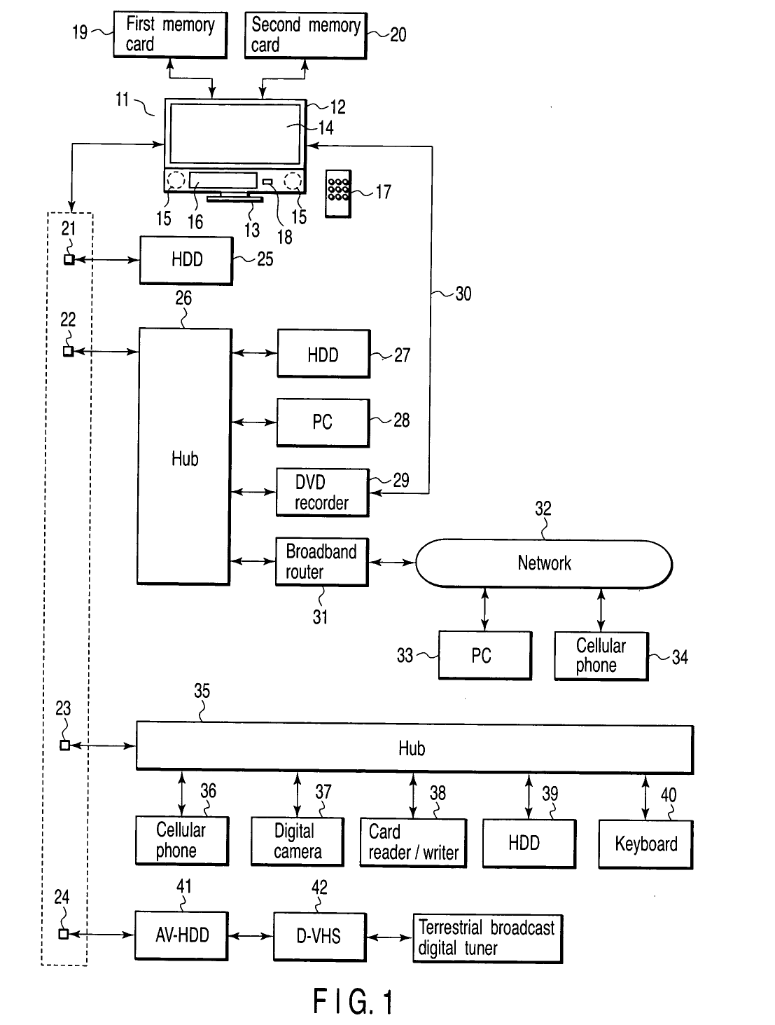

Hereinafter, an embodiment of the invention will be explained by referring to the drawings. FIG. 1 shows an external view of a digital television broadcast receiver 11 to be explained in this embodiment and schematically shows an example of a network system configured around the broadcast receiver 11 as a center.

The broadcast receiver 11 composed mainly of a thin cabinet 12 and a support base 13 making the cabinet 12 raised and supported. The cabinet 12 is provided with a flat panel type video display unit 14 composed of, for example, a liquid crystal display panel, a loudspeaker 15, an operation unit 16 and a light receiving unit 18 to receive operation information transmitted from a remote controller 17.

The broadcast receiver 11 detachably has a first memory card 19 being such as a secure digital (SD) memory card, a multimedia card MMC and a memory stick and performs recording/reproducing of information such as a program or a photograph to and from the first memory card 19.

The broadcast receiver 11 further detachably has a second memory card (IC card) 20 with, for example, contract information recorded thereon and performs recording/reproducing of information related to the contract information to the second memory card 20.

The broadcast receiver 11 is provided with a first local area network (LAN) terminal 21, a second LAN terminal 22, a universal serial bus (USB) terminal 23 and an i.Link (registered trade mark) terminal 24.

Among these parts, the first LAN terminal 21 is used as a LAN-compatible HDD dedicated port. The first LAN terminal 21 is connected to a LAN-compatible HDD 25 being a network attached storage (NAS). The first LAN terminal 21 is used to record/reproduce information to an HDD 25 through Ethernet (registered trade mark).

As mentioned above, by providing the first LAN terminal 21 to be the LAN-compatible HDD dedicated port, the network system can stably perform information recording with a high image quality of the program to the HDD 25 without being influenced by other network environments or the state of application of the network.

The second LAN terminal 22 is use as a general LAN-compatible port. The second LAN terminal 22 is connected to equipment such as a LAN-compatible HDD 27, a personal computer (PC) 28 and a digital versatile disk (DVD) recorder 29 with a built-in HDD thorough a hub 26 via, for example, a hub 26 and used in information communication between these parts and the broadcast receiver 11.

Since digital information communicated through the second LAN terminal 22 is information of a control system, the DVD recorder 29 requires a dedicated analog transmission path 30 to transmit analog information of video and sound to the broadcast receiver 11.

The second LAN terminal 22 is connected to, for example, a network 32 such as the Internet via a broadband router 31 connected to the hub 26 and used to communicate information between a PC 33 or a cellular phone 34, etc., and the broadcast receiver 11 via a network 32.

The USB terminal 23 is used as a general USB-compatible port, connected to, for example, a cellular phone 36, a digital camera 37, a card reader/writer 38 for a memory card, an HDD 39 and a keyboard 40 and used to make information communication between the equipment and the broadcast receiver 11.

The i.Link terminal 24 serially connects an AV-HDD 41, digital (D)—video home system (VHS) 42, etc., and makes the information communication between the equipment and the broadcast receiver 11.

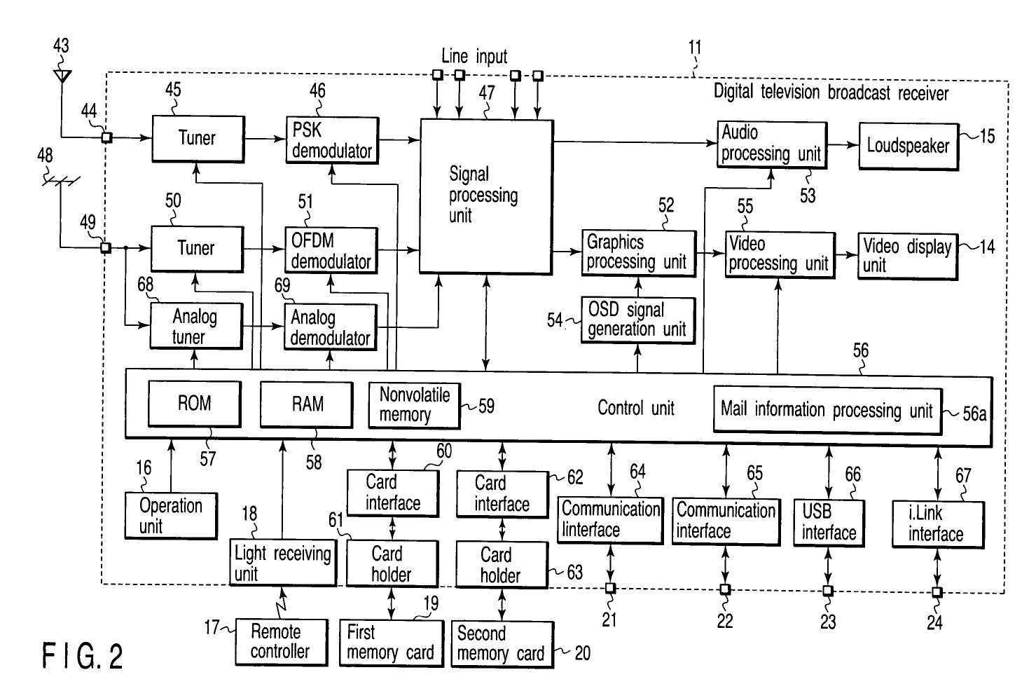

FIG. 2 shows the principal signal processing system of the foregoing broadcast receiver 11. That is, a satellite digital television broadcast signal received at an antenna 43 for receiving DBS/CS digital broadcasts is supplied to a tuner 45 for satellite digital broadcasting through an input terminal 44 and the tuner 45 tunes a broadcast signal of a desired channel.

The broadcast signal tuned by the tuner 45 is supplied to a phase shift keying (PSK) demodulator 46 to be demodulated to a digital video signal and a sound signal then output to a signal processor 47.

A terrestrial digital television broadcast signal received at an antenna 48 for receiving terrestrial digital television broadcast is supplied to a tuner 50 for the terrestrial digital television broadcast via an input terminal 49 and the tuner 50 tunes the broadcast signal of the desired channel.

The broadcast signal tuned by the tuner 50 is supplied to an orthogonal frequency division multiplexing (OFDM) demodulator 51 to be demodulated to a digital video signal and an audio signal then output to the signal processor 47.

This signal processing system also has an analog tuner 68 to receive a terrestrial analog signal. The signal received by the analog tuner 68 is demodulated by an analog demodulator 69 and output to the signal processor 47.

Where the signal processor 47 selectively conducts prescribed digital signal processing on the video signals and sound signals supplied from the PSK demodulator 46 and the OFDM demodulator 51 and to the video signals and analog signals supplied from the analog demodulator 69 and the line input terminals and outputs an output signal to a graphic processor 52 and a sound processor 53.

The graphic processor 52 has a function to superimpose an on-screen display (OSD) signal generated from an OSD signal generator 54 on the digital video signal supplied from the signal processor 47 and output the superimposed signal. The graphic processor 52 can selectively output the video signal output from the signal processor 47 and the OSD signal output from the signal generator 54 and output both outputs so that both outputs configure a half of a screen, respectively.

The digital video signal output from the graphic processor 52 is supplied to a video processor 55. The video processor 55 converts the input digital video signal into an analog video signal in a format possible to be displayed on the video display unit 14 and outputs the analog video signal to the video display unit 14 to make a video display.

The sound processor 53 converts an analog sound signal in a format possible to be reproduced by the loud speaker 15 and outputs to the loud speaker 15 to make a sound reproduction.

The broadcast receiver 11 integrally controls the whole operations including the above-mentioned various types of receiving operations by means of a control unit 56. The control unit 56 has a built-in central processing unit (CPU), etc., receives operation information from the operation unit 16, or receives operation information transmitted from the remoter controller 17 and respectively controls each part so as to reflect operation contents to each part.

In this case, the control unit 56 mainly uses a read only memory (ROM) 57 with a control program to be executed by the CPU stored thereon, a random access memory (RAM) 58 to provide an operation area to the CPU and a nonvolatile memory 59 to which a variety of items of setting information and control information.

The control unit 56 is connected to a card holder 61 to which the first memory 19 can be attached through a card interface 60. The control unit 56 thereby can make information communication with the first memory card 19 attached to the card holder 61 through the card interface 60.

The control unit 56 is connected to a card holder 63 to which a second memory card 20 can be attached through a card interface 62. The control unit 56 thereby can make information communication with the second memory card 20 attached to the card holder 63 through the card I/F 62.

The control unit 56 is connected to the first LAN terminal 21 through a communication interface 64. The control unit 56 thereby can perform information communication with the LAN-compatible HDD 25 connected to the first LAN terminal 21 through the communication interface 64. In this case, the control unit 56 has a dynamic host configuration protocol (DHCP) server section and assigns an internet protocol (IP) address to the LAN compatible HDD 25 connected to the first LAN terminal 21 and controls the HDD 25.

The control unit 56 is connected to the second LAN terminal 22 through a communication interface 65. The control unit thereby can make information communication with each equipment (refer to FIG. 1) connected to the second LAN terminal 22 through the communication interface 65.

The control unit 56 is connected to the USB terminal 23 through an USB interface 66. The control unit 56 thereby can perform information communication with each equipment (refer to FIG. 1) connected to the USB terminal 23 through the USB interface 66.

The control unit 56, furthermore, is connected to the i.Link terminal 24 through an i.Link interface 67. The control unit 56 thereby can make information communication with each equipment (refer to FIG. 1) connected to the i.Link terminal 24 through the i.Link interface 67.

The control unit 56 includes a mail information processor 56a to be an important constitute element of the embodiment of the invention. The detailed faction of this information processor 56a will be explained later.

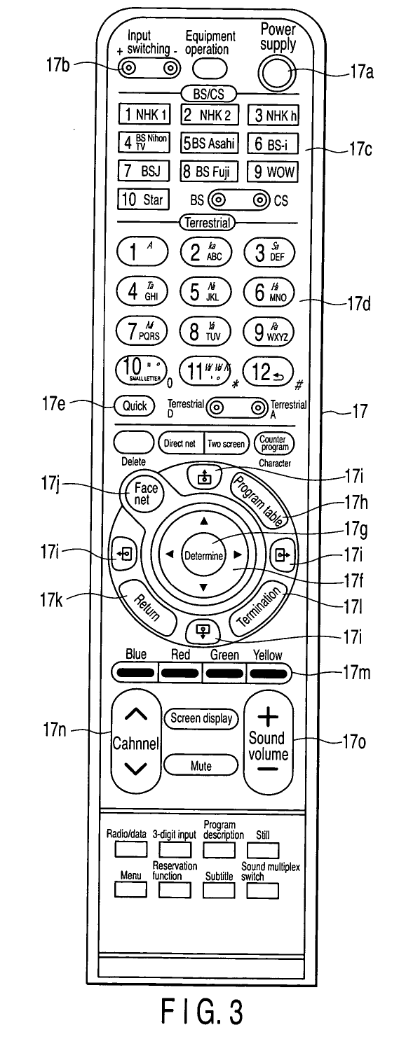

FIG. 3 shows the external view of the remote controller 17. The remote controller 17 mainly comprises a power supply key 17a, input switching keys 17b, direct tuning keys for satellite broadcast channels 17c, direct tuning keys of terrestrial broadcast channels 17d, a quick key 17e, a cursor key 17f, a determination key 17g, a program table key 17h, page switching keys 17i, a face net (registered trade mark) (navigation) key 17j, a return key 17k, a termination key 171, color keys in blue, red, green, yellow 17m, a channel up down key 17n, a sound volume adjusting key 17o, etc.

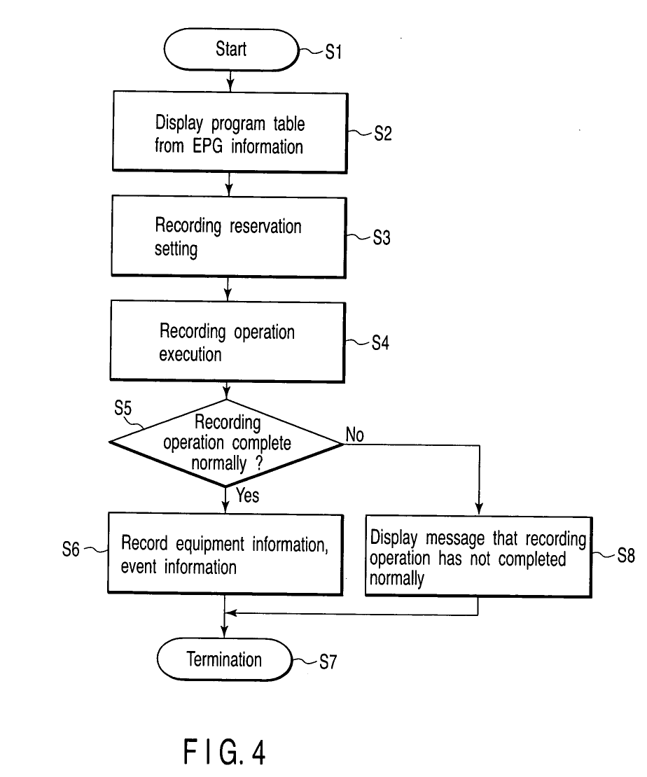

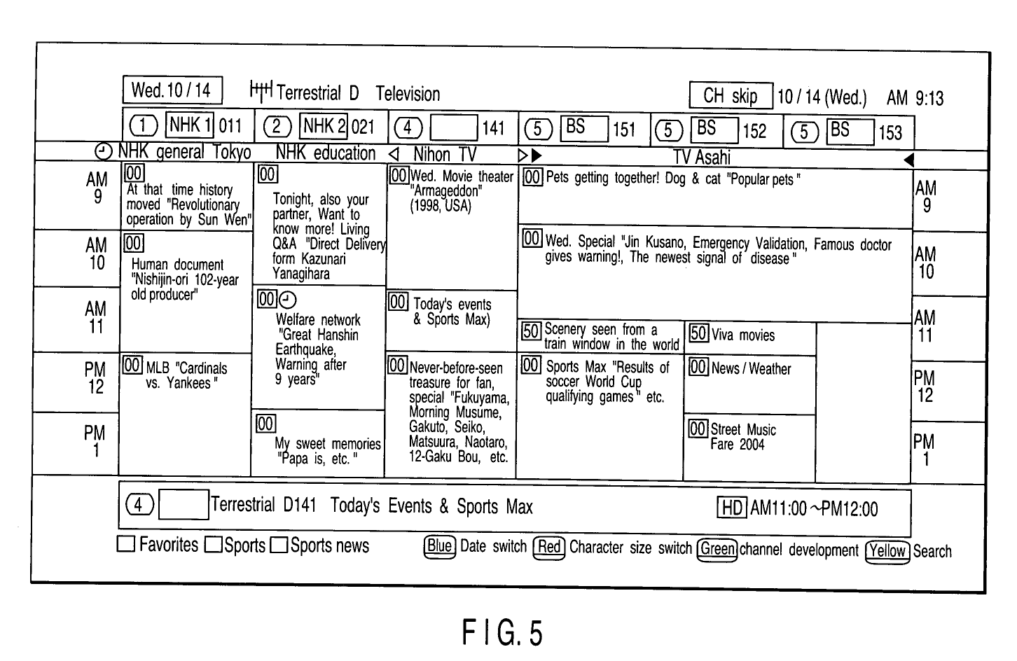

FIG. 4 shows the flowchart for explaining operations of the broadcast receiver 11 to record the program into the digital recording equipment among each of the equipment connected to the terminals 21-24 of the broadcast receiver 11. When processing is started resulting from a request of the recording of the program (step S1), the control unit 56 displays the program table as shown in FIG. 5 on the basis of electronic program guide (EPG) information acquired from the broadcast signal (step 2).

The user then executes recording reservation setting of the desired programs on the basis of the displayed program table (step S3). In this setting, the broadcast receiver 11 selects the program to be recorded and also selects to set the digital recording equipment to which the reservation-set program is recorded.

The control unit 56 executes a recording operation so as to record the reservation-set program into the reservation-set digital recording equipment when it has reached the preset time for a recording reservation (step S4).

The control unit 56 then determines whether or not the program recording operation has normally completed, and if it is determined that the operation has completed normally (Yes, in step S5), the broadcast receiver 11 records equipment information (equipment ID, equipment name, shared folder name, etc.) to specify the digital recording equipment which has performed recording and event information (event ID, the channel number, title, content explanation, category, recording range, image quality mode, etc.) related to the recorded program into the nonvolatile memory 59 (step S6) and terminates this processing (step S7).

If it is determined that the operation has not completed normally (No, in step S5), the control unit 56 displays the massage indicating the fact that the operation has not completed normally onto the display unit 14 (step S8) and terminates this processing (step S7).

According to recording operations described above, the user can arbitrarily select a plurality of sets of digital recording equipment connected to each terminal 21-24 of the broadcast receiver 11 and record programs sequentially.

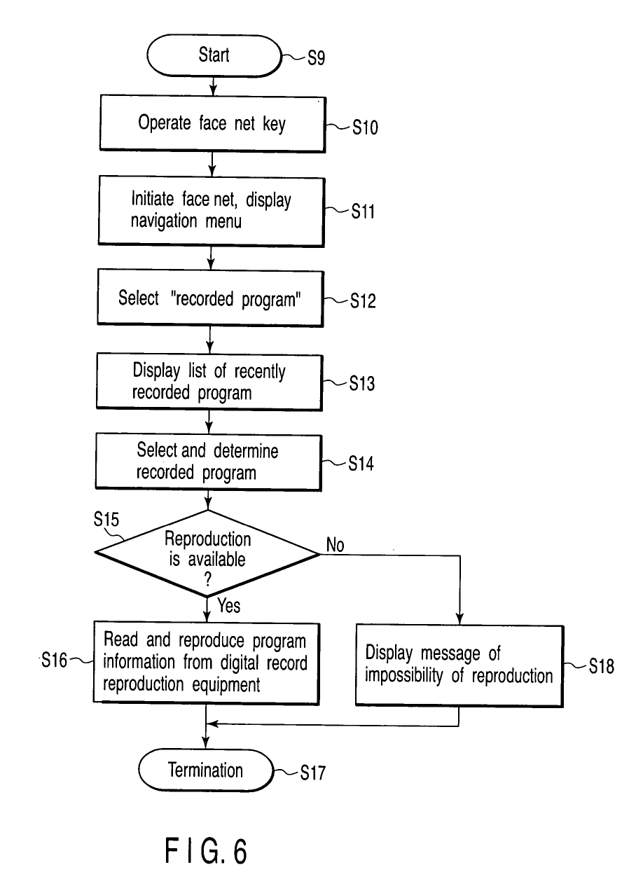

FIG. 6 shows the flowchart for explaining operations to quickly retrieve the desired program and reproduce it among a variety of programs recorded in the plurality of sets of the digital recording equipment a mentioned above. When the processing starts (step S9), the user operates the face net key 17j of the remote controller 17 (step S10).

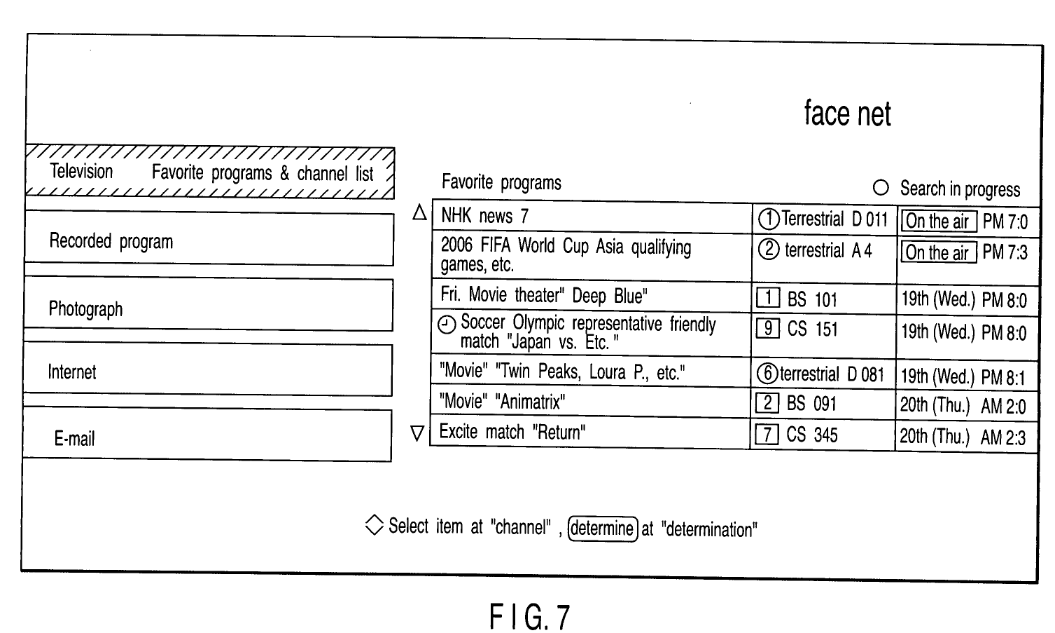

The control unit 56 then starts up the face net (navigation) and displays the navigation menu as shown in FIG. 7 onto the video display unit 14 (step S11). Five items of “television”, “recorded program”, “photograph”, “Internet” and “E-mail” are selectively provided in this menu. The selected items are displayed on a screen in different color from other items, and a state in which the item of “television” is selected is indicated by hatching in FIG. 7.

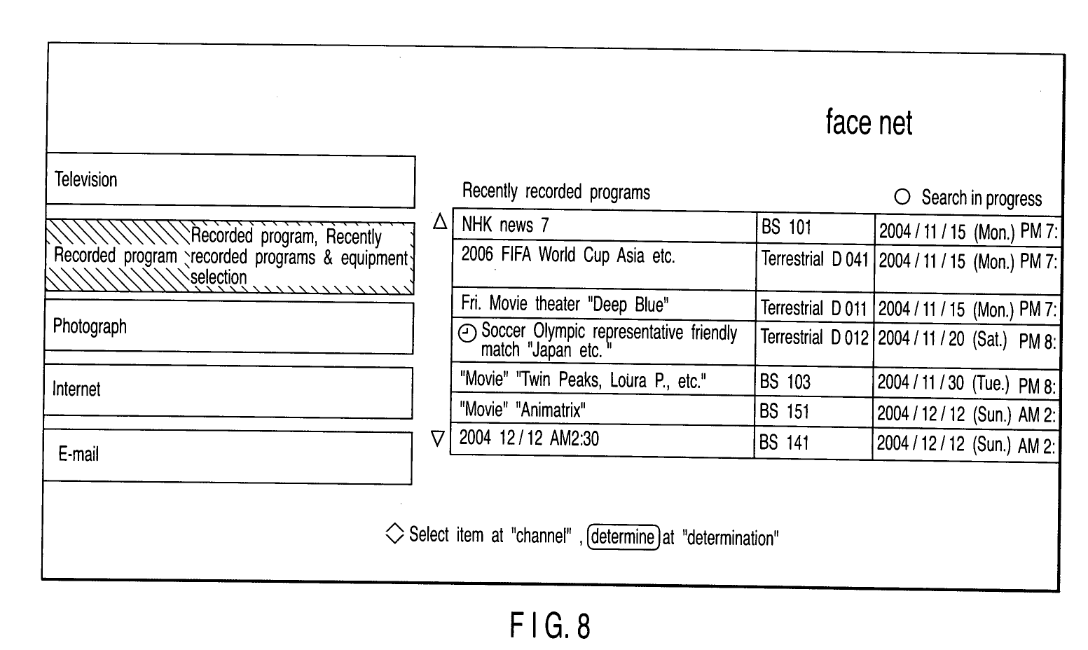

Here, it is assumed that the user operates the cursor key 17f of the remote controller 17 and selects the item of “recording program” (step 12). The control unit 56 then is brought into a state of selection of the item “recording program” as shown in FIG. 8.

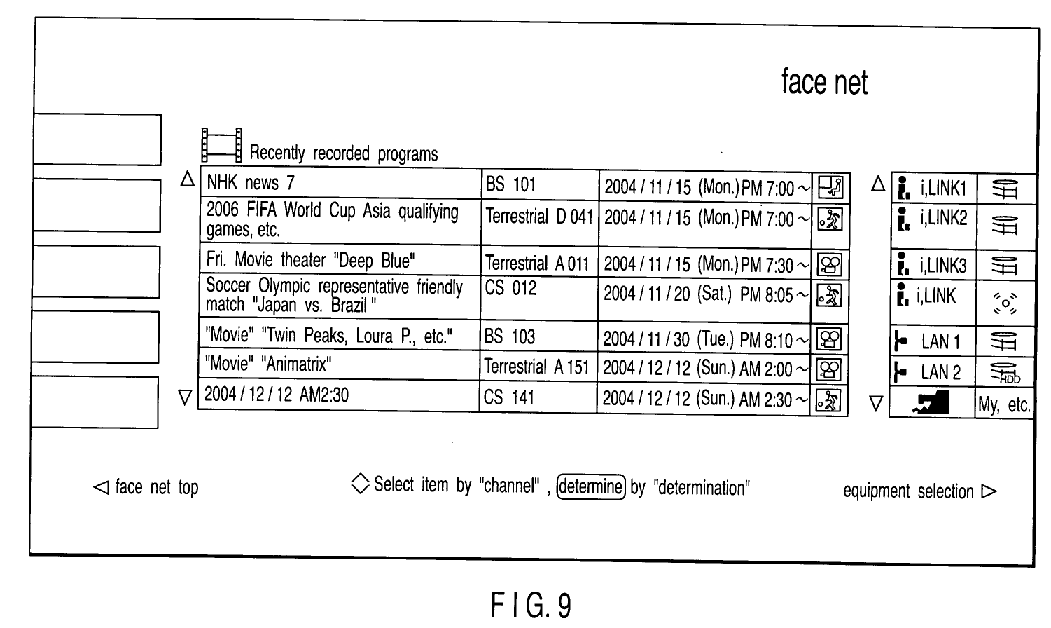

In this state, when the user operates the determination key 17g of the remote controller 17 (step s13), the control unit 56 displays a list of the recently recorded programs onto the video display unit 14 as shown in FIG. 9. In this program list, the title, broadcast channel, recording date, day of the week, time, category, etc., are displayed as information indicating the recorded program.

The list of the recently recorded programs is created by referring to equipment information specifying the digital recording equipment which has recorded and event information in relation to recorded programs recorded on the nonvolatile memory 59 in reservation recording of the programs explained in FIG. 4. In this list, it is possible to display, in a list, information indicating thirty-five programs at a maximum as far back as the reproduction-requested program recorded therein. In FIG. 9, though seven programs are displayed in a list, the user can see the list of thirty-five programs by operating the cursor key 17f to scroll the display. If the user operates the page switching keys 17i of the remote controller 17, the user can skip the seven programs displayed in a list at once.

When the user operates the cursor key 17f of the remote controller 17 to select information indicating the desired program from the list of the recently recorded programs and operates the determination key 17g to determine it (step S14), the control unit 56 specifies the digital recording equipment with the selected and determined program recorded therein from information recorded in the nonvolatile memory 59 and determines whether or not the program is possible to be reproduced (step S15).

This determination determines whether the program can be reproduced or not by comprehensively comparing various conditions in recording and reproducing, for example, by determining whether or not the broadcast receiver 11 is connected to the digital recording equipment with the reproduction-requested program recorded therein, whether or not power is tuned on to the digital recording equipment with the reproduction-requested program recorded therein, whether or not the program is still recorded in the targeted digital recording equipment, etc.

If it is determined that the program can be reproduced (Yes, in step S15), the control unit 56 reads out information about the reproduction-requested program from the targeted digital recording equipment to control to reproduce the program (step S16) then terminates this processing (step S17).

If it is determined that the program cannot be reproduced (No, in step S15), the control unit 56 displays a message indicating the fact that the requested program can not be reproduced onto the video display unit 14 and terminates this processing (step S17).

According to the forgoing reproduction operations, since the broadcast receiver 11 has a navigation section to display, in a list, the thirty-five recorded programs at a maximum as far back as from the newest recorded program regardless of the digital recording equipment with the desired program recorded therein, the user can easily manage the programs recorded in a plurality of sets of digital recording equipment. Accordingly, it becomes possible to quickly retrieve and reproduce the desired program by selecting by the cursor key 17f and determining by the determination key 17g among programs displayed in the list.

Considering the increase in the number of connected sets of the digital recording equipment and the recorded programs, it becomes impractical to display in a list the whole of programs recorded in the plurality of sets of the recording equipment. As the embodiment stated above, it is a practical setting to hardly cause a substantial problem for the user to display at a list up to the thirty-five programs at a maximum as far back as from the newest recorded program.

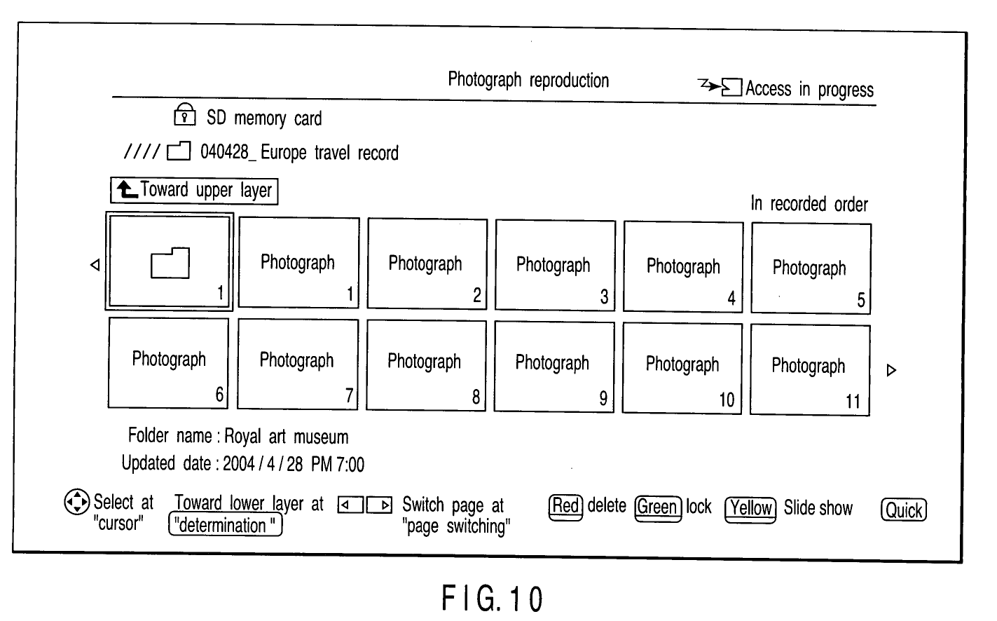

The broadcast receiver 11 has a photograph reproduction section. The broadcast receiver 11 can display in a list, for example, a plurality of photographs recorded on the SD memory card being the first memory card 19 attached to the card holder 61 by selecting to determine the item of “photograph” among the navigation menu shown in FIG. 7 displayed by operating the face net key 17j of the remote controller 17. In this case, it is necessary for the user to specify the digital recording medium or digital recording equipment (digital camera). As a result, the photograph list shown in FIG. 10 is displayed.

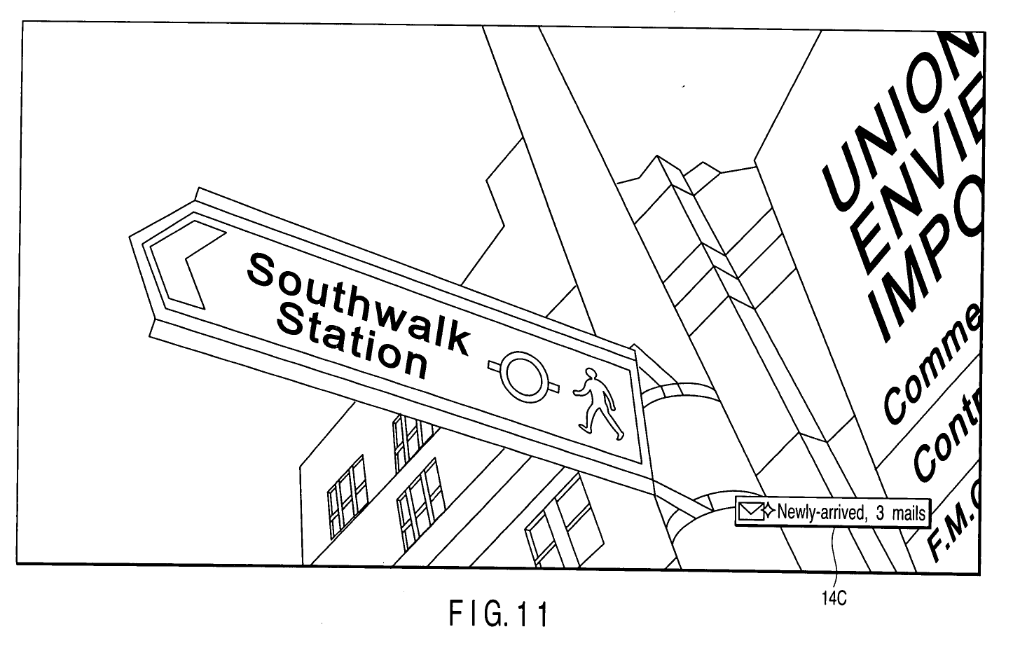

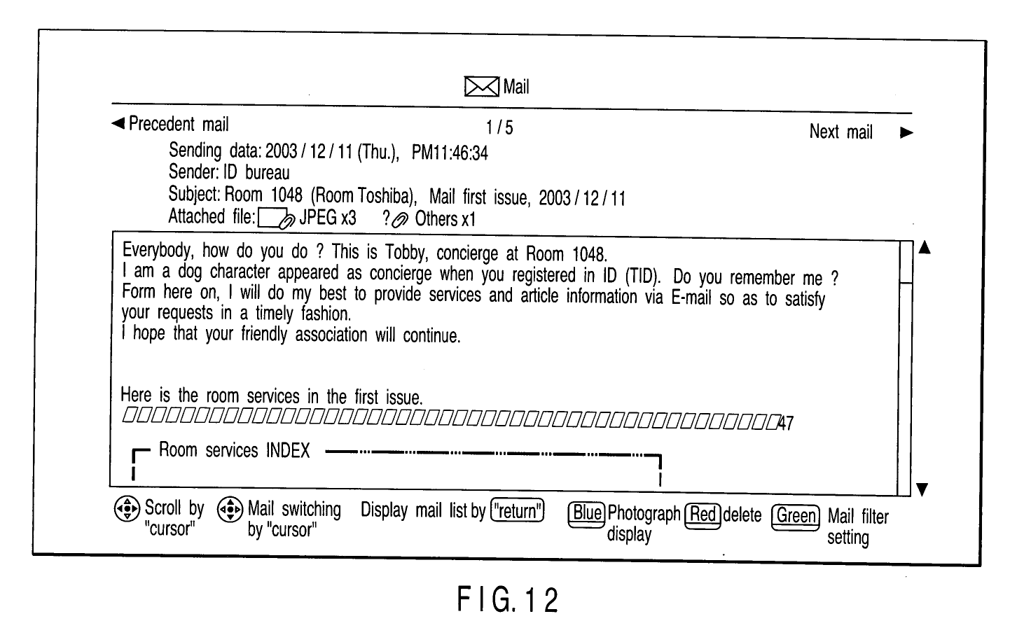

The broadcast receiver 11 periodically accesses to a server to determine the incoming state of the E-mail, and if there is incoming of the E-mail, the broadcast receiver 11 can display an incoming message 14c such as “newly arrived three mails” onto a display screen on the video display unit 14 as shown in FIG. 11. In a state of display of the incoming message, the broadcast receiver 11 can open the E-mail on the video display unit 14 as shown in FIG. 12 only by operating the determination key 17g of the remote controller 17.

The broadcast receiver 11 also can specify the desired PC 28, 33 to transmit the E-mail and read out the received E-mail even by selecting and determining the item of “E-mail” from the navigation menu shown in FIG. 7.

The broadcast receiver 11 can switch the video displayed on the screen of the video display unit 14 on a page basis by operating the page switching keys 17i of the remote controller 17. That is, the cursor key 17f of the remote controller 17 is composed of four keys corresponding to each direction of upward, downward and right, left so as to move the cursor in directions of upward, downward and right, left on the screen.

For example, if the user operates the page switching key 17i corresponding to the cursor key 17f to move the cursor upward, a current display screen can be switched to the video existent on the upper side of the display screen. Owing to this page switching section, it becomes possible to select the desired screen in shorter time than when scrolling the screen by operating the cursor key 17f.

Since the page switching keys 17i are provided in accordance with the cursor key 17f, the moving directions can be easily recognized by the user. The page switching keys 17i can switch such screens of the program table shown in FIG. 5 and of the list of recently recorded programs shown in FIG. 9.

This broadcast receiver 11 effectively utilizes the mail reception processing section for the E-mail. The processing section can receive and process the normal mail and the function control mail as the E-mail. Wherein, the normal mail means the mail for transmitting information in characters like a document text as explained by referring FIG. 10 and FIG. 11, and the function control mail means the mail including control data in order to control a plurality of sets of peripheral equipment attached to the broadcast receiver 11 and make a recording reservation, as described below. When the normal mail or the function control mail is newly arrived, the broadcast receiver 11 prevents the user from being confused and enhances the convenience for the user by improving a method for displaying an icon on the display unit 14.

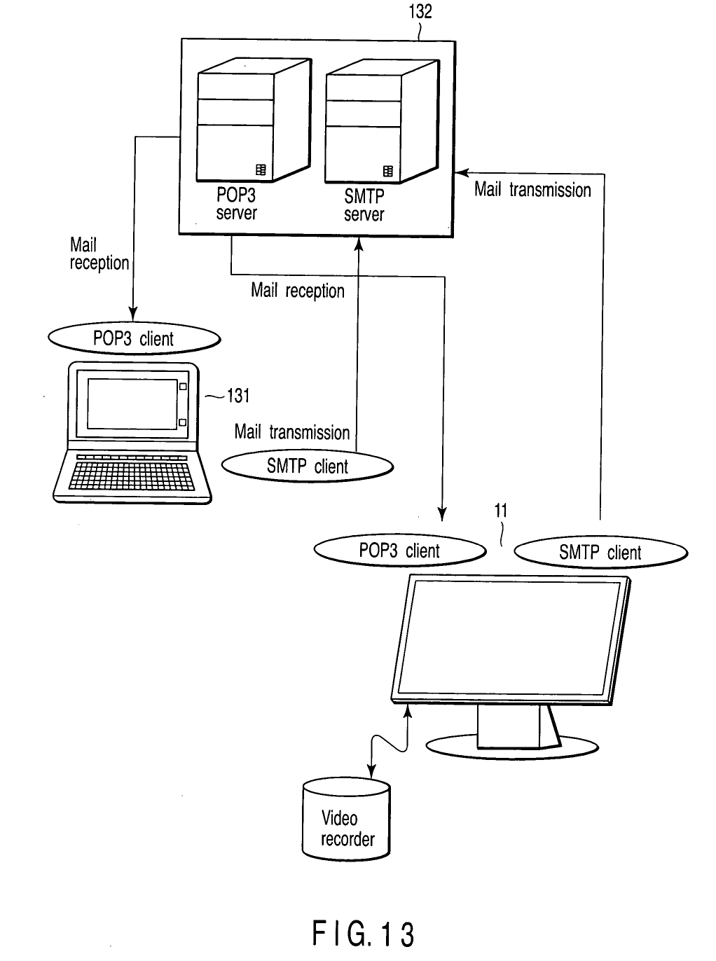

Hereinafter, the mail reception processing section will be explained. FIG. 13 shows an example of paths for mail transmission/reception via the Internet. An external PC 131 is operated and the mail is transmitted. The transmitted mail arrives at the broadcast receiver 11 through a server 132. The broadcast receiver 11 can be also connected to a keyboard. The broadcast receiver 11 can transmit the mail by operating the keyboard, because the broadcast receiver 11 has the mail processing section.

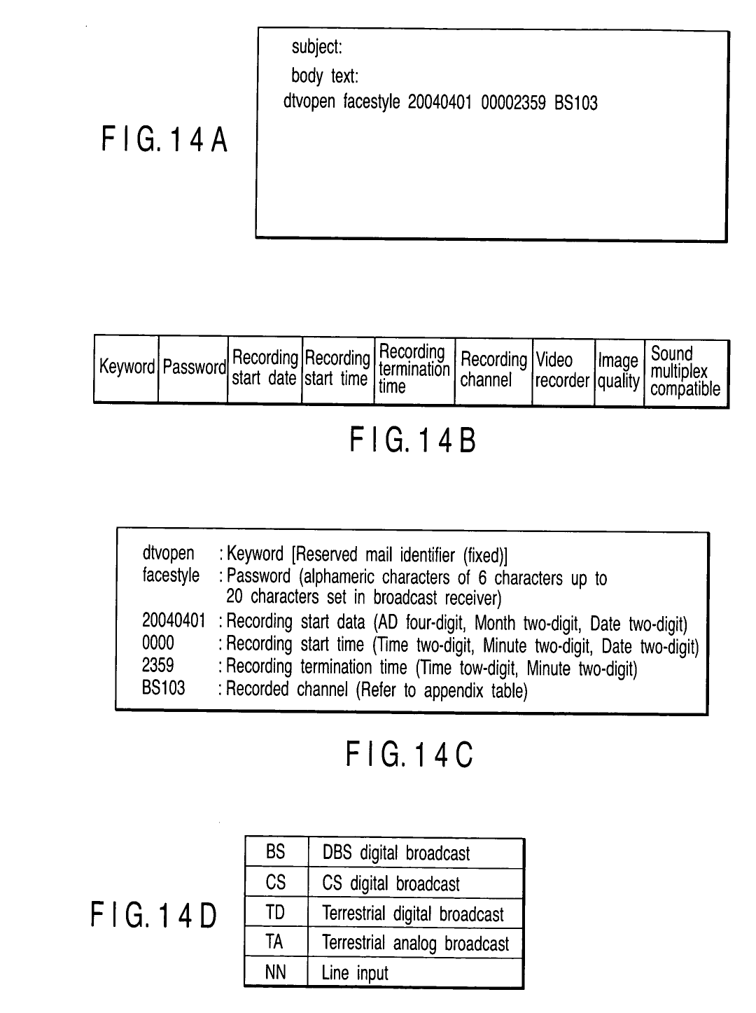

FIG. 14A-FIG. 14D are the views for explaining examples of the formats of the function control mail. FIG. 14A shows, for example, an example of a body text of the function control mail to be transmitted at the time of making the recording reservation on the display screen of the cellular phone or the display screen of the PC 131 shown in FIG. 13. A graphic depiction of a transmission address input unit is omitted in FIG. 14A.

In the body text, as shown in FIG. 14A and FIG. 14B, in the event of the function control mail, control data of “keyword”, “password”, “video recording start data”, “video recording start time”, “video recording termination time”, “video recorded channel”, “video recorder”, “image quality, video recording mode” and “sound multiplex compatible” is sequentially arranged.

FIG. 14C shows a specific example each of “keyword: dtvopen”, “password: facestyle”, “video recording start data”, “video recording start time”, “video recording termination time” and “video recorded channel”. In this example, the keyword is “dtvopen” and the password is “facestyle”. The video recording start data is input by four-digit year, two-digit month and two-digit day. The video recording start time and termination time are input by time two-digit and minute two-digit, respectively. Input data is assigned for the video recorded channel as shown in FIG. 14D. “BS” is for BS digital broadcast, “CS” is for CS digital broadcast, “TD” is for terrestrial digital broadcast, “TA” is for terrestrial analog broadcast and “LN” is for a line input. After the inputs of respective “BS”, “CS”, “TD” and “TA”, the numbers of the desired channels are input by using alphameric characters. After the input of “LN”, the number of line is input. FIG. 14A shows an example in which the 103 channel of the BS digital broadcast is brought into a reservation. For example, the inputs CS001, TD011, TA1, TAC13, TABS1 mean specifications of the 001 channel of the CS digital broadcast, the 011 channel of the terrestrial digital broadcast, the 1 channel of the terrestrial analog broadcast, the C13 channel of the CATV, and the 1 channel of the analog satellite broadcast, respectively.

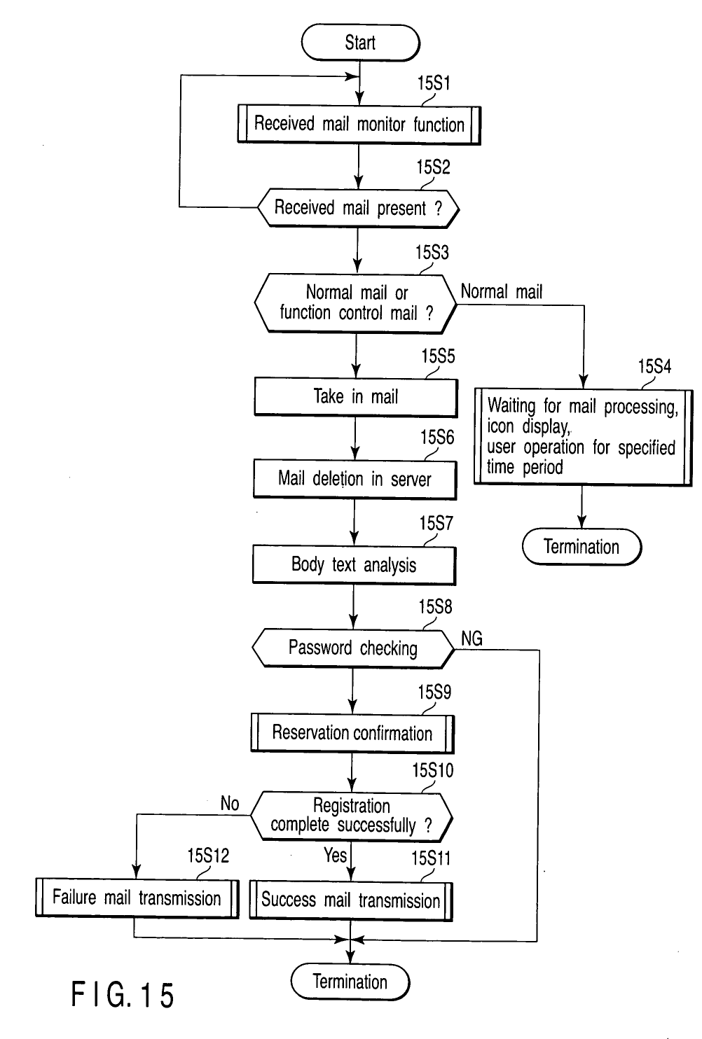

FIG. 15 shows operations, as a flowchart, when the broadcast receiver 11 receives the forgoing function control mail. This mail processing section may be provided in the control unit 56 shown in FIG. 2 or in an individual block separately.

The broadcast receiver 11 periodically starts this mail processing section. When starting the processing section, the broadcast receiver 11 checks the arrival of the mail at the server 132 by the received mail monitoring section (step 15S1). If the mail has arrived at the server 132, it is determined whether the received mail is the normal mail or the function control mail (steps 15S2, 15S3). The mail types are identified by means of the operation of the mail type identification section. In the event of the normal mail, the received mail is performed mail processing, and the processing shown in FIG. 11 and FIG. 12 can be executed. The received mail is processed though of mail list-display processing and mail body text-display processing. In the event of the function control mail, the received mail is taken in (step 15S5), mails in the server 132 are deleted (step 15S6) then the body text of the received mail is analyzed (step 15S7). Next, the broadcast receiver 11 checks the password, and if the password is erroneous, terminates this processing section. If the password is correct in checking the password, the broadcast receiver 11 executes confirmation processing for the reservation, in other words, reads the video recording reservation information shown in FIG. 14B and registers the reservation information in the program reservation table (steps 15S8, 15S9 and 15S10). In the event of success of registration, the broadcast receiver 11 replies with a success mail, and in the event of failure of the registration, the broadcast receiver 11 replies with a failure mail including the fact of the failure (steps 15S11 and 15S12).

The message of the failure mail includes information about the error of the specifications of data, the absence of the reserved channel, the absence of the recording equipment, etc. The broadcast receiver 11 can transmit the massages even in the case of overlapping of reservations, in the case of an excess of the number of reservation beyond the prescribed number, and in the case that the time up to the start time of the video recording is shorter than a prescribed time (for example, 5 minutes). The broadcast receiver 11 has a function to omit the mail list-display processing and the mail body text-display processing, if the received mail is the function control mail.

A video recorder identifier in the case of presence of the foregoing video recorder is VCRO or VCR1. The i.Link and the number are used by pairing with each other as like i.Link 1 and i.Link 2 in the case of specification of the i.Link equipment. When specifying the NAS equipment, the broadcast receiver 11 uses the NAS and the number by pairing with each other. When using the SD as for a video recording destination, the SD and the number are used by pairing like SD2, SD3, etc.

The broadcast receiver 11 can set a video recording mode. As for the video recording mode, the following specifications are available: TS (direct recording of a transport stream); XP (recording in a state with the highest bit rate after a down-conversion); SP (recording in a state with a bit rate lower than that of XP); LP (recording in a state with a bit rate lower than that of SP); EP (recording in a state with a bit rate lower than that of LP); F (default recorded with a fine rate and appropriately selected in advance); N (default recorded with a normal rate and appropriately selected in advance); and E (default recorded with an economic rate and appropriately selected in advance). As for double sound recording mode, the following identifiers are available: N (recording of main sound); S (recording of sub sound); and MS (recording of main+sub sound).

In such a receiver has a section to make a list display of a reservation status in the case that the foregoing reservation of the video recording program is made. On an operation of the menu button of the remote controller 17, the item of “reservation” is appeared on the screen. When operating the determination button by putting a cursor onto the item of “reservation”, the items of “date specification reservation” and “reservation list” are appeared on the screen. On operation of the determination button by putting the cursor onto the item of “reservation list”, a list table showing the reservation status is displayed. On the table of the reservation list, “channel logo” and “channel number” are displayed. The item of “program name as title” is displayed. The item of “reserved data” is displayed, and at this time, this item may be displayed in such an item “every day” or “every week (month)”. Furthermore, the reserved time is also displayed.

Accordingly, the user, accordingly, can confirm the video recording reservation status though the E-mail, on the screen later. The user, of course, can display the reservation list table and operate to cancel the reservation.

This broadcast receiver 11 is devised so as to allow dealing with the case of no specification of the video recorder, no specification of the image quality and no specification of the sound multiplex compatible information, when the function control mail is received. In other words, this broadcast receiver 11 presets a prescribed video recorder (equipment with the lowest set number), an image quality, and sound multiplex compatible information to store them in a storage unit, as defaults. Accordingly, the broadcast receiver 11 has a section to use the default information, when information necessary for the function control mail is omitted. The broadcast receiver 11 has a storage unit with information used at the last minute (information about the video recorder previously used, the image quality, sound multiplex compatibility) and information already used several times before the last minute stored therein, so that the broadcast receiver 11 can use the information.

As stated above, the broadcast receiver 11 has the tuner unit to receive the broadcast signal, the signal processing unit to process and reproduce the signal received by the tuner unit, and the graphics processing unit to superimpose the graphic signal stored in advance on the display signal acquired by the signal processing unit. The broadcast receiver 11, further, has the mail receiving section. Then the broadcast receiver 11 has a mail type identification section to identify the normal mail and the function control mail when the mail receiving section receives E-mail and has a display processing unit to display a mail incoming icon through the graphic processing unit when the received mail is the normal mail. The broadcast receiver 11 has a video recording reservation processing unit to omit the display of the forgoing mail incoming icon, generate the video recording reservation information by analyzing at least the keyword, the recorded channel and the recorded time and make the video recording reservation when the received mail is the function control mail.

Here, the mail receiving section includes a function to periodically monitor the server 132. The mail receiving section has a means to reply the failure mail to the transmission origin of the function control mail when the broadcast receiver 11 fails to make the video recording reservation. The display processing unit can delete the mail incoming icon after the elapse of a specified time period. The recording processing unit includes a means to store the video recording reservation information into the storage unit. The display processing unit includes a means to display program brief information stored in the storage unit onto the display unit.

The invention is not limited to the specific details and representative embodiments shown and described herein, and in an implementation phase, various types of modifications may be made without departing from the spirit or scope of the general inventive concept of the invention. Various types of the invention can be formed by appropriately combining a plurality of constituent elements disclosed in the foregoing embodiments. Some of the elements, for example, may be omitted from the whole of the constituent elements shown in the embodiments mentioned above. The constituent elements over different embodiments further may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiver, comprising:
a mail receiving section;
a mail type identification section to identify a normal mail and a function control mail when the mail receiving section receives a mail; and
a recording reservation section to generate recording reservation information by analyzing at least a keyword, a recording channel and a recording time in the function control mail and make a recording reservation when the received mail is the function control mail.

2. The broadcast receiver according to claim 1, wherein the function control mail further includes information to specify a video recorder and the broadcast receiver has a section to specify a video recorder corresponding to information specifying the video recorder.

3. The broadcast receiver according to claim 2, wherein the function control mail further includes information to specify an image quality and the broadcast receiver has a section to set a video recording mode in the video recorder on the basis of the information to specify the image quality.

4. The broadcast receiver according to claim 3, wherein the broadcast receiver has a means to use specification information stored in a storage unit in advance when the information to specify the video recorder or the information to specify the image quality is blank.

5. A broadcast receiver, comprising:
a tuner unit to receive a broadcast signal;
a signal processing unit to process and reproduce the broadcast signal acquired by the tuner unit;
a graphic processing unit to superimpose a graphic signal stored in advance on a display signal acquired by the signal processing unit and output the superimposed signal to a display unit;
a mail receiving section;
a mail type identification section to identify a normal mail and a function control mail when the mail receiving section receives mail;
a display processing unit to display a mail incoming icon through the graphic processing unit when the received mail is the normal mail; and
a video recording reservation processing unit to omit a display of the mail incoming icon, generate video recording reservation information by analyzing at least a keyword, a video recording channel and a video recording time in the function control mail and make a video recording reservation when the received mail is the function control mail.

6. The broadcast receiver according to claim 5, wherein the mail receiving section includes a section to periodically monitor a server.

7. The broadcast receiver according to claim 5, wherein the mail receiving section has a means to reply a failure mail to a transmission origin of the function control mail when the video recording reservation is failed to be made.

8. The broadcast receiver according to claim 5, wherein the display processing unit deletes the mail incoming icon after the elapse of a specified time.

9. The broadcast receiver according to claim 5, wherein the video recording reservation processing unit has a means to store the video recording reservation information into a storage unit.

10. The broadcast receiver according to claim 5, wherein the display processing unit has a means to display program brief information stored in the storage unit in response to an operation signal from a remote controller.

11. A method for receiving broadcast receiving a broadcast signal by a tuner unit having a network connecting terminal, an external equipment connecting terminal, and a control unit to control operations, making a signal processing unit process and reproduce the signal acquired by the tuner unit, making a graphic processing unit superimpose a graphics signal on a display signal acquired by the signal processing unit and outputting a composite signal acquired by superimposing processing to a display unit, wherein
the control unit
includes a mail information processing unit,
identifies a normal mail and a function control mail when receiving a mail
displays a mail incoming icon through the graphic processing unit when the received mail is the normal mail, and
omits a display of the mail incoming icon, generates video recording reservation information by analyzing at least a keyword, a video recording channel and a video recording time in the function control mail and makes a video recording reservation when the received mail is the function control mail.

12. The method for receiving broadcast according to claim 11, wherein the function control mail further includes information to specify a video recorder and the method specifies a video recorder corresponding to the information to specify the video recorder.

13. The method for receiving broadcast according to claim 12, wherein the function control mail further includes information to specify an image quality and the method setting a video recording mode in the video recorder on the basis of the information to specify the image quality.

14. The method for receiving broadcast according to claim 13, wherein the method uses specification information stored in a storage unit in advance when the information to specify the video recorder or the information to specify the image quality is blank.
